(19) United States
(12) Patent Application Publication
(10) Pub. No.: US 2015/0135466 A1
(43) Pub. Date: May 21, 2015

(54) LOCKING COUPLER FOR WIPER ASSEMBLY

(71) Applicant: TRICO PRODUCTS CORPORATION, Rochester Hills, MI (US)

(72) Inventor: John Foss, Troy, MI (US)

(73) Assignee: TRICO PRODUCTS CORPORATION, Rochester Hills, MI (US)

(21) Appl. No.: 14/083,982

(22) Filed: Nov. 19, 2013

(51) Int. Cl. B60S 1/38

(52) U.S. Cl. CPC B60S 1/3863; B60S 1/381
USPC 15/250.201; 15/250.32

(57) ABSTRACT

A locking coupler is used to connect a wiper assembly to a wiper arm. The wiper assembly includes a wiping element adapted to contact a surface to be wiped. The wiper assembly also includes at least one elongated support member acting to support the wiping element. The wiper assembly further includes an airfoil operatively mounted to the at least one elongated support member and the wiping element. The wiper assembly includes a locking coupler for attaching the wiping element, the at least one elongated support member, and the airfoil together.

### BACKGROUND OF THE INVENTION

1. Field of the Invention

The present invention relates generally to wiper assemblies for vehicles and, more specifically, to a locking coupler for a wiper assembly for a vehicle.

2. Description of the Related Art

Conventional wiper assemblies for vehicles known in the related art include some type of wiper assembly mounted to a wiper arm which, in turn, is mounted adjacent a surface to be wiped such as a windshield of the vehicle and pivotally driven to impart reciprocal motion to the wiper assembly across the windshield. The wiper assembly typically includes a rubber wiping element that contacts the windshield across the surface to be wiped. The wiper assembly often incorporates one or more metal strips that act to reinforce the wiping element and facilitate wiping contact by the wiping element across what is typically a curved glass surface. In this context, the wiper arm delivers a downward force to the wiper assembly that is distributed thereacross pressing the wiper assembly into contact with the windshield. The wiper assembly may also include an airfoil and a pair of end caps located at the distal ends of the wiper assembly. The wiper assembly may also include a coupler that connects the wiper assembly to the wiper arm.

Current technology of wiper assemblies utilizes one of three methods for attaching components of a wiper assembly together. These components include a wiper element, support spline, airfoil, and coupler. The first method includes bonding the wiper element to a single support spline and attaching an airfoil. The second method includes sandwiching the wiping element between a set of support splines which are held together by end caps. The third method includes carrying the wiper element by a channel in the airfoil with a support spline that feeds through the airfoil and a channel in the coupler, the system being then held together with end caps to prevent the spline from sliding out of the airfoil.

In the methods above, it is desired to eliminate the need for end caps for distal retention of the wiping element and support spline. The end caps add additional labor and can increase cost associated with adding such parts. Therefore, there is a need in the art for attaching components of a wiper assembly together that eliminates the need for end caps.

### SUMMARY OF THE INVENTION

The present invention overcomes the disadvantages in the related art in a locking coupler adapted to attach a wiper assembly to a wiper arm. The locking coupler includes a base portion adapted to be disposed over a portion of an airfoil of the wiper assembly and an attachment portion extending outwardly from the base portion and adapted to connect to the wiper arm. The base portion includes at least one elongated claw adapted to be disposed in at least one notch of a wiping element of the wiper assembly to retain the wiping element and at least one locking arm having a tab portion adapted to be disposed in at least one notch of the airfoil and at least one notch of at least one support member of the wiper assembly for attaching the wiping element, the at least one support member, and the airfoil together.

In addition, the present invention is a wiper assembly including a wiping element adapted to contact a surface to be wiped. The wiper assembly also includes at least one elongated support member acting to support the wiping element. The wiper assembly further includes an airfoil operatively mounted to the at least one elongated support member and the wiping element. The wiper assembly still further includes a locking coupler adapted to attach to a wiper arm and for attaching the wiping element, support member, and airfoil together.

In this way, the locking coupler of the present invention attaches components of a wiper assembly together and eliminates the need for end caps. The locking coupler of the present invention prevents accidental disassembly. In addition, the locking coupler of the present invention reduces the manufacturing complexity and number of components, thus reducing overall cost. The locking coupler of the present invention can be used for wiper systems in any type of transportation from automotive vehicles, heavy-duty trucks, trains, air planes, ships, large construction vehicles, or military vehicles or any other type of vehicles that contain surface wiper systems.

Other objects, features, and advantages of the present invention will be readily appreciated as the same becomes better understood after reading the subsequent description taken in connection with the accompanying drawings.

### BRIEF DESCRIPTION OF THE DRAWINGS

FIG. 1 is a partial perspective view of a front of a vehicle having a pair of wiper assemblies, according to one embodiment of the present invention, pivotally mounted for reciprocal movement across a windshield of the vehicle.

FIG. 2 is an enlarged top perspective view of one of the wiper assemblies, according to one embodiment of the present invention, of FIG. 1.

FIG. 3 is an enlarged bottom perspective view of the wiper assembly, according to one embodiment of the present invention, of FIG. 2.

FIG. 4 is a perspective view of a locking coupler, according to one embodiment of the present invention, and a portion of the wiper assembly of FIGS. 2 and 3.

FIG. 5 is a bottom perspective view of a locking coupler, according to one embodiment of the present invention, and a portion of the wiper assembly of FIGS. 2 and 3.

FIG. 6 is a perspective view of a locking coupler, according to one embodiment of the present invention, and a portion of the wiper assembly of FIGS. 2 and 3.

FIG. 7 is a perspective view of the locking coupler, according to one embodiment of the present invention, of FIGS. 4 through 6.

FIG. 8 is a perspective view of a portion of the wiper assembly of FIGS. 2 and 3 with the locking coupler, according to one embodiment of the present invention, of FIGS. 4 through 6 removed.

FIG. 9 is a perspective view of the locking coupler, according to one embodiment of the present invention, of FIGS. 4 through 6 and a portion of the wiper assembly of FIGS. 2 and 3 with the locking coupler of FIG. 7 illustrated in phantom lines.

FIG. 10 is a sectional view taken along lines 10-10 of FIG. 4.

FIG. 11 is a sectional view taken along lines 11-11 of FIG. 2.

### DETAILED DESCRIPTION OF THE PREFERRED EMBODIMENT(S)

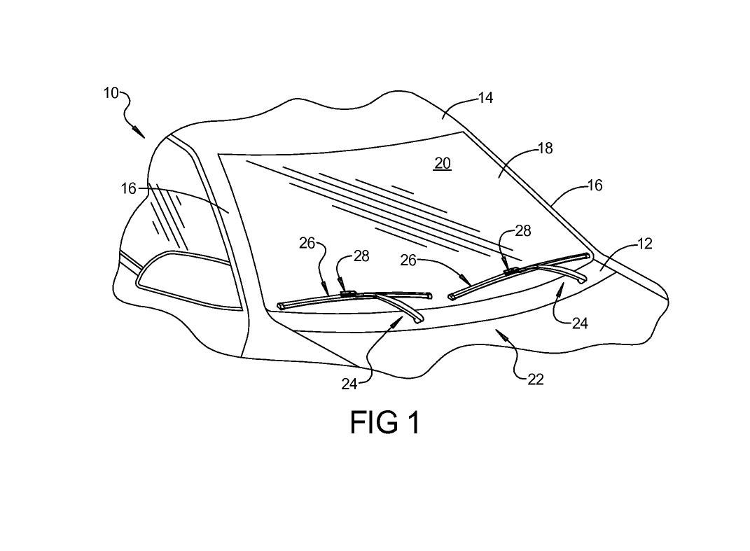

Referring now to the figures, where like numerals are used to designate like structure, a portion of a vehicle is schematically illustrated at 10 in FIG. 1. The vehicle 10 includes a cowl 12, a roof 14, and a pair of laterally spaced front or “A” pillars 16 extending between the roof 14 and the cowl 12. The A-pillars 16, roof 14, and cowl 12 cooperate to define a generally rectangular opening 18 in which is supported a curved or “swept back” glass windshield 20. As illustrated, the vehicle 10 is an automotive vehicle, but may be any type of vehicle such as heavy-duty trucks, trains, air planes, ships, large construction vehicles, or military vehicles or any other type of vehicle that contain surface wiper systems.

A wiper system is generally indicated at 22 in FIG. 1 and is employed to clean the windshield 20. The wiper system 22 includes a pair of wiper arms, generally indicated at 24, and a pair of wiper assemblies, according to the present invention and generally indicated at 26, which correspond to the driver and passenger side of the vehicle 10. However, those having ordinary skill in the art will appreciate that the wiper system 22 could employ a single wiper arm 24 and a single wiper assembly 26 without departing from the scope of the present invention.

In the representative example illustrated herein, each wiper assembly 26 is carried by a corresponding wiper arm 24. The wiper arm 24 includes an attachment member, generally indicated at 28, adapted to operatively engage the wiper assembly 26. The wiper system 22 also includes an electrical motor (not shown, but generally known in the art) to move the wiper assemblies 26 in an oscillating manner across the surface of the windshield 20.

While the wiper assembly 26 illustrated in FIG. 1 is shown in connection with the front windshield 20 of the vehicle 10, those having ordinary skill in the art will appreciate that wiper assemblies 26 may be employed in other areas of the vehicle 10, such as a rear window (not shown) or a head lamp (not shown) that employs a wiper system. Thus, it will be understood that the present invention is not limited for use solely in connection with wiper arms 24 adapted for use on a vehicle's windshield 20, but for use in all applications where wiper arms 24 are employed.

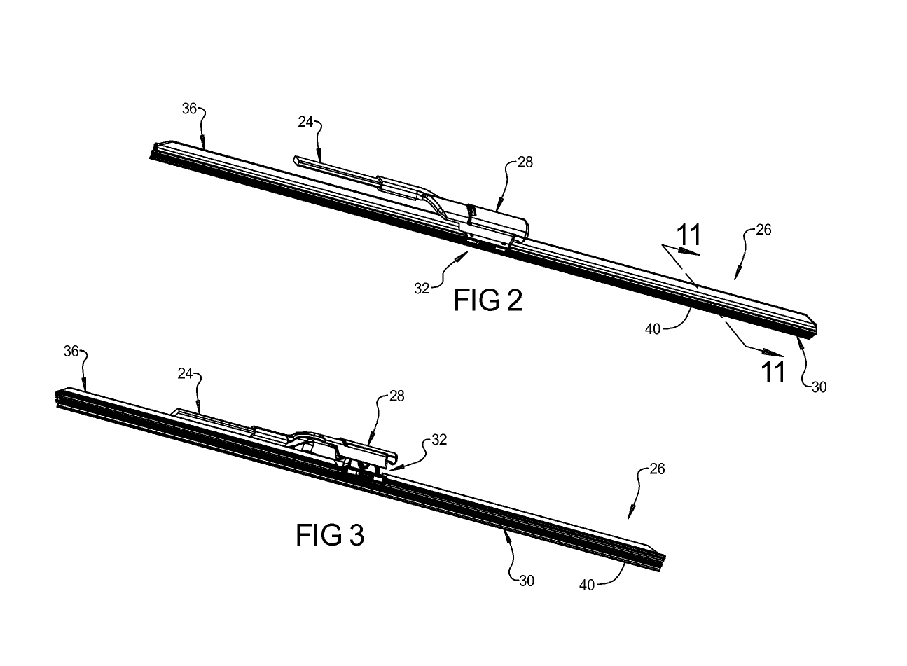

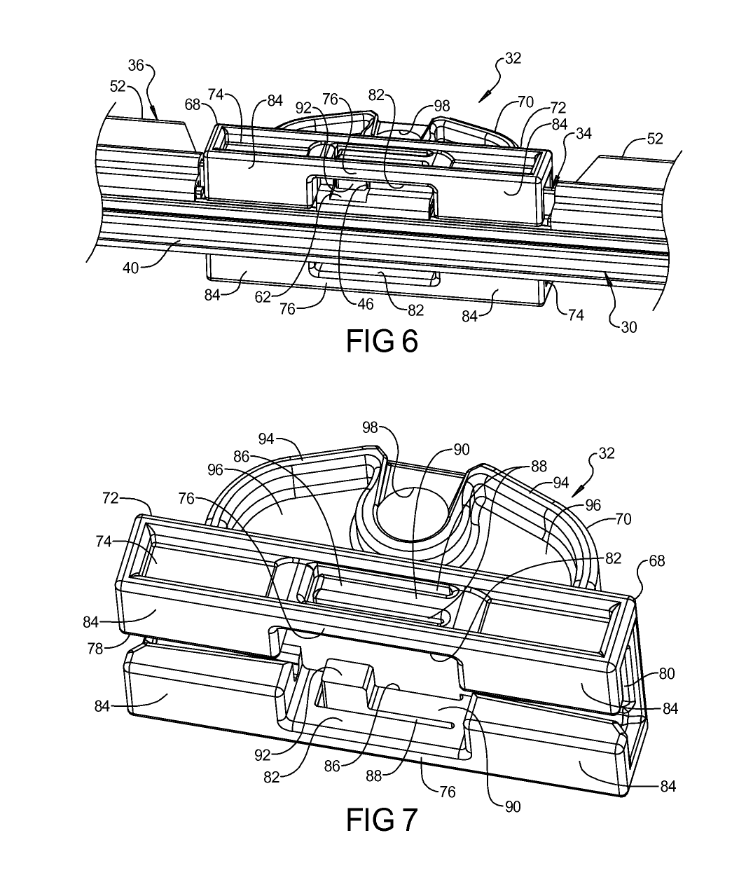

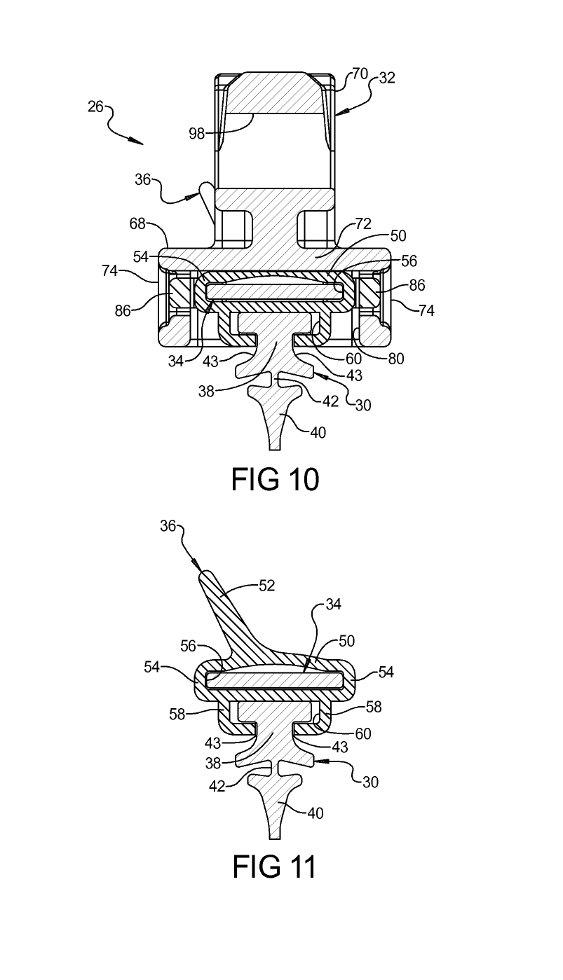

Referring to FIGS. 2 through 11, the wiper assembly 26 includes a wiping element, generally indicated at 30, that is adapted to contact the surface of the vehicle 10 to be wiped, in this representative example, the windshield 20. In addition, the wiper assembly 26 generally includes a locking coupler, generally indicated at 32, that acts to connect to the wiper arm 24 and attach components of the wiper assembly 26 together. The wiper assembly 26 also includes at least one support member, generally indicated at 34, that defines a longitudinal axis and that acts to reinforce or support the wiping element 30. In the representative embodiment illustrated herein, the support member 34 is a beam or spline to operatively reinforce or support the wiping element 30. However, those having ordinary skill in the art will appreciate from the description that follows that the support member 34 may be either monolithic or defined by the pair of splines. The wiper assembly 26 may also include an airfoil assembly, generally indicated at 36, to prevent the wiper assembly 26 from lifting from the surface of the windshield 20. Each of the above components will be described in greater detail below.

As illustrated in FIGS. 2 through 11, the wiping element 30 includes an upper section or portion 38 and a lower section or portion 40 that are partitioned by a longitudinally extending bridge or hinge section or portion 42. The hinge portion 42 provides flexibility between the upper portion 38 and lower portion 40 during operational movement of the wiper assembly 26 across the surface to be wiped. The upper section 42 includes opposed grooves 43 extending laterally therein and longitudinally therealong between its ends. The grooves 43 cooperate with the airfoil 36 as will be described in detail below. The upper section 42 also includes one or more notches 44 extending laterally therein. In the embodiment illustrated, the notches 44 are located near the center of the wiping element 30. One notch 44 extends laterally into each side of the wiping element 30 such that the notches 44 oppose each other. The notches 44 are generally rectangular in shape, but may be any suitable shape. The notches 44 cooperate with the locking coupler 32 as will be described in detail below. The wiping element 30 also includes a predetermined length corresponding to particular application and is often manufactured through an extrusion process, which enables the length of the wiping element 30 to be easily adjusted without a substantial increase to manufacturing expense. Furthermore, while the wiping element 30 of the present invention is constructed from a flexible rubber, those having ordinary skill in the art will appreciate that it may be constructed from any flexible material such as silicone or other polymer without departing from the scope of the present invention.

The support member 34 may be constructed from a resiliently flexible material, such as spring steel or a polymer, and is adapted to apply force from an intermediate position between its longitudinal ends. More specifically, the support member 34 receives force from the spring-loaded wiper arm 24 at an intermediate position and distributes this force across the span of the support member 34 toward its longitudinal ends. To that end, the support member 34 may be curved longitudinally with a predetermined radius of curvature. This predetermined radius of curvature is sometimes referred to in the related art as a “free form” radius of curvature. Accordingly, the curvature of the support member 34 may be symmetrical or asymmetrical depending on the force requirements and the contour of the windshield 20. The flexible, free form, pre-curved support member 34 straightens out when the wiper arm 24 applies a force thereto to flatten the support member 34 and directs the wiping element 30 to contact the windshield 20. Thus, the elongated support member 34 includes a free-form curvature that ensures force distribution on windshields having various curvatures and that effects proper wrapping about the windshield 20.

As illustrated throughout the figures, the support member 34 has a substantially constant width and may have a constant thickness throughout the length between its longitudinal ends. The constant width and thickness are adapted to provide high lateral and torsional stiffness to avoid lateral and torsional deflection, which causes the wiping element 30 to stick/slip (“chatter”) on the windshield 20 during operation. Thus, the cross-section of the support member 34 has a generally rectangular outer profile that makes the support member 34 easier to manufacture. More specifically, where the support member 34 is constructed from metal, such as spring steel, the tools and machinery used to manufacture the support member 34 are less complicated than that required to manufacture having varying widths and/or thicknesses. Furthermore, where the support member 34 is constructed from a polymer, such as a thermoplastic elastomer, the tools and extrusion process machinery are also less complicated than those employed to manufacture beams having varying widths and/or thicknesses. However, those having ordinary skill in the art will appreciate that the support member 34 illustrated herein may include a varying thickness and/or width without departing from the scope of the present invention.

Additionally, the support member 34 may include one or more notches 46 extending therein. In the embodiment illustrated, the notches 46 are located near the center of the support member 34. One notch 46 extends into each side of the support member 34 such that the notches 46 oppose each other. The notches 46 are generally rectangular in shape, but may be any suitable shape. The notches 46 cooperate with the locking coupler 32 as will be described in detail below.

As noted above, the wiper assembly 26 also includes a locking coupler, generally indicated at 32. The locking coupler 32 is adapted to connect the wiper assembly 26 to the wiper arm 24 and for attaching components of the wiper assembly 26 together. More specifically, those having ordinary skill in the art will appreciate that different OEM' s employ wiper arm assemblies having different attachment members adapted to operatively engage a specific wiper assembly. Accordingly, the locking coupler 32 illustrated herein includes structure that operatively engages at least one or more of these different attachment members. Further by way of example, certain wiper arms employed by OEM' s include “bayonet-style”; “pin-type”; or “hook-type” attachment members of various sizes that operatively engage the wiper assemblies.

As previously noted, the wiper assembly 26 includes the airfoil, generally indicated at 36, to prevent the wiping assembly 26 from lifting from the surface of the windshield 20. The airfoil 36 is operatively mounted to the wiping element 30 and the support member 34. The airfoil 36 extends along the length of the wiping element 30 and the support member 34. The airfoil 36 acts to reduce the likelihood of wind lift by allowing air to flow over the wiper assembly 26. More specifically, and in the embodiment illustrated herein, the airfoil 36 includes a single unitary component that is operatively mounted to the wiping element 30 and the support member 34 with the locking coupler 32 extending therebetween. However, those having ordinary skill in the art will appreciate that the airfoil 36 may be defined by a pair of airfoil components without departing from the scope of the present invention.

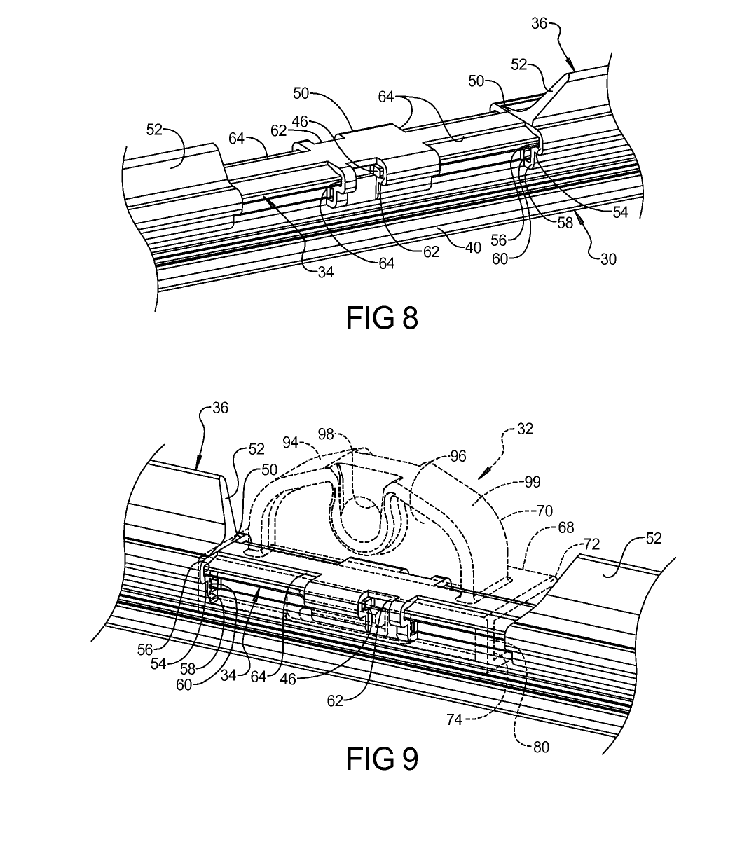

Referring to FIG. 8, the airfoil 36 includes a body 50 extending longitudinally. The airfoil 36 includes a spoiler 52 that tapers outwardly from the body 50 toward a terminal point to define a profile that is slightly contoured. The body 50 includes first channel members 54 extending downwardly opposite the spoiler 52. The first channel members 54 are generally “C” shaped to form a first channel 56 to receive the support member 34. In the embodiment illustrated, the first channel members 54 are connected along a bottom thereof to enclose the first channel 56. The body 50 also includes second channel members 58 extending downwardly from the first channel members 54. The second channel members 58 are generally “C” shaped to form a second channel 60 to receive at least a portion of the upper portion 38 of the wiping element 30. The first channel members 54 extend laterally outward a distance greater than the second channel members 58. The airfoil 36 also includes one or more first notches 62 extending therein. In the embodiment illustrated, the first notches 62 are located near the center of the body 50. One first notch 62 extends into each side of the body 50 such that the first notches 62 oppose each other. The first notches 62 are generally rectangular in shape, but may be any suitable shape. The airfoil 36 further includes one or more second notches 64 extending therein. In the embodiment illustrated, the second notches 64 are located and longitudinally spaced from the first notches 62. In the representative embodiment, one pair of second notches 64 is spaced longitudinally on one side of the first notches 62 and another pair of second notches 64 is spaced on the other side of the first notches 62. One second notch 64 extends into each side of the body 50 such that the second notches 64 oppose each other. The second notches 64 are generally rectangular in shape, but may be any suitable shape. The notches 62 and 64 cooperate with the locking coupler 32 as will be described in detail below. In addition, the airfoil 36 may be manufactured through an extrusion process. However, those having ordinary skill in the art will appreciate that the airfoil 36 may be manufactured using any other conventional mechanism.

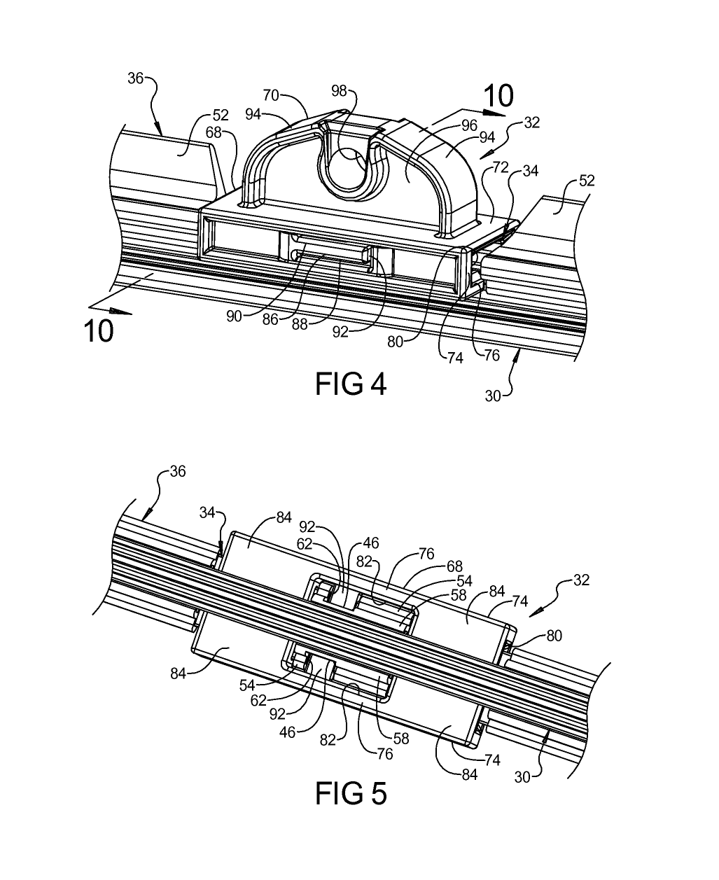

Referring to FIGS. 4 through 11, the locking coupler 32 cooperates with and attaches the wiping element 30, support member 34, and airfoil 36 together. The locking coupler 32 includes a base portion 68 for attaching the wiping element 30, support member 34, and airfoil 36 together and an attachment portion 70 that extends outwardly away from the base portion 68 for attaching to the attachment member 28 of the wiper arm 24. The base portion 68 includes a top wall 72 and a pair of side walls 74 extending from the top wall 72. The top wall 72 is generally rectangular in shape. The side walls 74 are generally rectangular in shape and extend generally perpendicular from each longitudinal side of the top wall 72. The base portion 68 includes a flange wall 76 extending laterally inwardly from each of the side walls 74 to form a space or slot 78 therebetween extending longitudinally and a channel 80 extending longitudinally between the top wall 72 and the flange walls 76. The base portion 68 also includes an aperture 82 extending through each of the flange walls 76 to form a pair of elongated claws 84. The aperture 82 is generally rectangular in shape. The base portion 68 further includes a locking arm 86 formed from each of the side walls 74 and extending into the aperture 82. Each of the side walls 74 includes one or more slots 88 extending therein to form the locking arm 86 with an arm portion 90 that is cantilevered to the side wall 74 and can be deflected laterally relative to the side wall 74. The locking arm 86 also has a tab portion 92 extending laterally inwardly into the aperture 82. The tab portion 92 is generally rectangular in shape. The tab portion 92 is displaceable into and out of the first notches 62 in the airfoil 36 and the notches 46 in the support member 34. It should be appreciated that the locking arm 86 locks or retains the coupler 32 and support member 34 together and from longitudinal movement relative to each other.

The attachment portion 70 extends generally perpendicular from the top wall 72. In one embodiment, the attachment portion 70 is generally rectangular in shape with arcuate portions 94 along the top thereof. The attachment portion 70 may include opposed recessed portions 96 extending laterally therein. The attachment portion 70 includes an aperture 98 extending laterally through the recessed portions 96 to receive a pin (not shown) of the attachment member 28. The locking coupler 32 is made of a rigid material such as plastic. The locking coupler 32 is integral, unitary, and one-piece.

In operation, the wiper assembly 26 is assembled by sliding the wiping element 30 into the airfoil 36. The upper portion 38 of the wiping element 30 is slid into the second channel 60 of the airfoil 36. Next, the locking coupler 66 is placed over the notches 62 and 64 in the airfoil 36. The elongated claws 84 are disposed in the second notches 64 and the tab portion 92 of the locking arms 86 is disposed in the first notches 62. After that, the elongated support member 34 is slid into the airfoil 36. The elongated support member 34 is slid into the first channel 56 of the airfoil 36 and the channel 80 of the locking coupler 32 and deflects the tab portion 92 of the locking arms 86 laterally outward. The elongated support member 34 continues to slide in the channel 80 of the locking coupler 32 until the notches 46 in the support member 34 are aligned with the tab portion 92 of the locking arms 86. Once aligned, the locking arms 86 deflect laterally inwardly and the tab portions 92 of the locking arms 86 are disposed in the notches 46 in the support member 34 to lock the locking coupler 32 and elongated support member 34 together. It should be appreciated that the elongated claws 84 in the locking coupler 32 are disposed in the notches 44 in the wiping element 30 and the wiping element 30 is retained by elongated claws 84 in the locking coupler 32.

The present invention has been described in an illustrative manner. It is to be understood that the terminology which has been used is intended to be in the nature of words of description rather than of limitation. Many modifications and variations of the present invention are possible in light of the above teachings. Therefore, within the scope of the appended claims, the present invention may be practiced other than as specifically described.

What is claimed is:

1. A locking coupler adapted to attach a wiper assembly to a wiper arm comprising:
a base portion adapted to be disposed over a portion of an airfoil of the wiper assembly;
an attachment portion extending outwardly from said base portion and adapted to connect to the wiper arm; and
said base portion including at least one elongated claw adapted to be disposed in at least one notch of a wiping element of the wiper assembly to retain the wiping element and at least one locking arm having a tab portion adapted to be disposed in at least one notch of the airfoil and at least one notch of at least one support member of the wiper assembly for attaching the wiping element, the at least one support member, and the airfoil together.

2. A locking coupler as set forth in claim 1 wherein said base portion includes a body having a top wall, a pair of side walls extending from said top wall, a flange wall extending laterally inwardly from each of said side walls to form a slot therebetween, and a channel extending longitudinally between said top wall and said flange wall to receive the at least one support member of the wiper assembly.

3. A locking coupler as set forth in claim 2 wherein said base portion includes an aperture extending through said flange wall to form a pair of elongated claws.

4. A locking coupler as set forth in claim 2 wherein said locking arm comprises an arm portion cantilevered to said side wall and a tab portion extending laterally inwardly from said arm portion and being displaceable laterally relative to said side wall.

5. A locking coupler as set forth in claim 1 wherein said attachment portion includes an aperture extending laterally therethrough and adapted to receive an attachment member of the wiper arm.

6. A locking coupler as set forth in claim 1 wherein said base portion is integral, unitary, and one piece.

7. A locking coupler as set forth in claim 1 wherein said base portion is made of a plastic material.

8. A wiper assembly comprising:
a wiping element adapted to contact a surface to be wiped;
at least one elongated support member acting to support said wiping element;
an airfoil operatively mounted to said support member and said wiping element; and
a locking coupler adapted to attach to a wiper arm and for attaching said wiping element, said support member, and said airfoil together.

9. A wiper assembly as set forth in claim 8 wherein said locking coupler comprises a base portion attaching said wiping element, said support member, and said airfoil together and an attachment portion extending outwardly from said base portion and adapted to connect to the wiper arm.

10. A wiper assembly as set forth in claim 9 wherein said at least one elongated support member includes at least one notch extending therein.

11. A wiper assembly as set forth in claim 10 wherein said base portion includes at least one locking arm having a tab portion disposed in said at least one notch.

12. A wiper assembly as set forth in claim 9 wherein said wiping element includes at least one notch extending therein.

13. A wiper assembly as set forth in claim 12 wherein said base portion includes at least one elongated claw disposed in said at least one notch of said wiping element to retain said wiping element.

14. A wiper assembly as set forth in claim 9 wherein said airfoil comprises a body and a spoiler extending outwardly from the body.

15. A wiper assembly as set forth in claim 14 wherein said body includes at least one first notch extending therein and at least one second notch extending therein and longitudinally spaced from said at least one first notch.

16. A wiper assembly as set forth in claim 15 wherein said base portion includes at least one locking arm having a tab portion disposed in said at least one first notch of said body and at least one elongated claw disposed in said at least one second notch of said body.

17. A wiper assembly as set forth in claim 9 wherein said base portion includes a top wall, a pair of side walls extending from said top wall, a flange wall extending laterally inwardly from each of said side walls to form a slot therebetween, and a channel extending longitudinally between said top wall and said flange wall to receive said at least one elongated support member.

18. A wiper assembly as set forth in claim 17 wherein said base portion includes an aperture extending through each said flange wall to form a pair of elongated claws.

19. A wiper assembly as set forth in claim 18 wherein said locking arm comprises an arm portion cantilevered to said side wall and a tab portion extending laterally inwardly from said arm portion and being displaceable laterally relative to said side wall.

20. A wiper assembly for a windshield of a vehicle comprising:
a wiping element adapted to contact a surface of the windshield to be wiped, said wiping element including an upper portion, a lower portion, a hinge portion extending between said upper portion and said lower portion, and at least one notch extending into said upper portion;
at least one elongated beam having at least one notch extending therein;
an airfoil having a body with a first channel extending longitudinally to receive said at least one elongated beam, a second channel extending longitudinally to receive at least a portion of said upper portion of said wiping element, at least one first notch extending therein and at least one second notch extending therein and longitudinally spaced from said at least one first notch; and
a locking coupler having an attachment portion adapted to attach to a wiper arm and a base portion disposed over a portion of said airfoil and including at least one elongated claw disposed in said at least one first notch of said airfoil and said at least one notch of said wiping element to retain said wiping element and at least one locking arm having a tab portion disposed in said at least one first notch of said airfoil and said at least one notch of said at least one elongated beam for attaching said wiping element, said at least one elongated beam, and said airfoil together.
